(19) United States
(12) Patent Application Publication
(10) Pub. No.: US 2007/0061870 A1
(43) Pub. Date: Mar. 15, 2007

(54) Method and system to provide secure data connection between creation points and use points

(76) Inventors: Annsheng Ting, Los Altos Hills, CA (US); Tipin Ben Chang, Cupertino, CA (US)

Correspondence Address: ANN C. TING, 27430 ELENA RD, LOS ALTOS HILLS, CA, 94022, US

(21) Appl. No.: 11/521,419

(22) Filed: Sep. 14, 2006

Related U.S. Application Data
(60) Provisional application No. 60/717,037, filed on Sep. 15, 2005.

(51) Int. Cl. G06F 15/16

(52) U.S. Cl. 726/3

(57) ABSTRACT

A method and system for creating a secure network access method is provided. The system creates a secure network environment beyond the traditional network endpoints to include the contents transferred through the secure network, stored in the endpoint machine, and utilized by the applications residing on the endpoint machine.

### PRIORITY CLAIM

This application claims priority under 35 USC 119(e) and 120 to U.S. Provisional Patent Application Ser. No. 60/717,037, filed on Sep. 15, 2005 and entitled “Method and apparatus to provide secure data connection between creation and use points” the entirely of which is incorporated herein by reference.

### FIELD OF THE INVENTION

This invention relates to secure connections to support a new distributed environment where the data is created by certain member of a distributed environment, and the members of the distributed environment are related in various ways depending on various factors. The various members' relationships can be creators and users of the data, co-creators of the data, and the connection factors can be time based, scenario based as well as based on applications that used to access data.

### BACKGROUND OF THE INVENTION

With global economy, more and more relationships are remote in physical locations while close in interactions. Many inventions were created to detect and protect the enterprises from being attacked by “outsiders”. In the new economy, it became difficult to distinguish insiders from outsiders since both can be remote and outside of a firewall of a network, as well as one can turn into the other depending on time and roles. Hardly any secure connection mechanism existing today handles the protection at the individual member of the network level. For the few that did, it does not reach the point of creation and use embedded in the application itself. Furthermore, the use of the connection is still mostly to prevent attacking of the network instead of preventing the important information from leaking out of the network. The methods, that are for preventing information leaking, are mostly using similar to the attacking prevention mechanisms by reversing the direction of filtering and checking. This mechanism leaves many opportunities to leak information between the time and the place of creation and use. Moreover, the existing mechanisms cannot limit the information to be filtered to a certain project instead of enterprise wide. These mechanisms create tremendous overhead in deployment management and runtime performance overhead.

This invention is to provide a mechanism that solves these problems and is dynamic so it can be flexibly applied to various groups and projects of an enterprise.

### SUMMARY OF THE INVENTION

The invention is to create a secure network access method, called “virtual security domain”, as well as provide a domain policy management server where the virtual security domain configuration and real-time management inside a network can be easily performed. This invention allows the virtual security domains dynamically validated, modified, and deployed depending on the parties associated with the connection and the business use of them. The invented mechanism is used for both preventing internal sensitive information from leaking out and external objects from attacking and getting into the corporate network. The point of creation and use is the starting point and the end point of where the data is transmitted via the network, or received from the network. The essential technology in this invention is to extend the network connection of the data transmission to inside the true endpoint, where the software creates or access the data. This is done by intercepting the execution flow of the application that is used to create the data or consume the data without requiring any change to the intercepted application software. It then ensures the associated access policy of the data is conformed by using five parameters: when, where, why, how, what. The access policy is created and can be modified anytime during the network is operating. The control and management of the access policy is inside a policy server which interacts with the network access control mechanism in real-time. The data is encrypted at the point of creation and at the beginning of the connection. The data is decrypted on the fly when access is validated and granted, and the execution flow of the accessing program can then continue without any disruption. For higher level of security, monitoring is supplemented with event triggering for immediate notification of the access violation on any of the five factors. Tracking reports for policy adjustment and quality improvement measures are produced for tuning the virtual security domain if needed.

### BRIEF DESCRIPTION OF THE DRAWINGS

FIG. 1 illustrates the relationship among the domain policy server, domain client machine, domain proxy server in accordance with the invention,

FIG. 2 illustrates an example of two domain clients' computing devices in a virtual security domain communicating through a secure channel;

FIG. 3 illustrates further details of a virtual security domain residing on a computing device;

FIG. 4 illustrates an example of a domain client's computing device communicating to a domain proxy server through a secure channel to gain access to some content servers protected by the firewall;

### DETAILED DESCRIPTION OF A PREFERRED EMBODIMENT

The invention is particularly applicable to the forthcoming distributed world where endpoints are no longer machines, or users of the machine, but the user who is using a particular application using a particular data, which is/will be transmitted through the network. This new endpoint is much more dynamically different by time, use scenario, and people. It is with this new definition of the endpoint of a network connection, this invention will be described. It will be appreciated, however, that the system and method in accordance with the invention has greater utility since the modules in the virtual security domain can also be implemented in hardware or as a combination of hardware and software and the secure data connection can be implemented on various different types of computing devices.

In addition to the technology to implement the secure network access method, virtual security domain, the system provides a set of tools to manage the virtual security domain policy management server where the virtual security domain configuration and real-time management inside a network can be carried out when planning a network with these connections and maintaining this enhanced secure network. The basic access method and the tools together allow the virtual security domains dynamically validated, modified, and deployed depending on the parties associated with the connection and the business use of them and formed an enhanced security network. The enhanced security network replies upon the existing hardware and software network infrastructure each organization already has in place. The system adds their virtual domains which were defined by the domain manager and will be used to control these dynamically changing endpoints during runtime. That is, even if the connection is up and data is transmitted by the existing network infrastructure, it may not get connected or the data may not get transmitted as useful decrypted data if the virtual security domain's access policy does not permit.

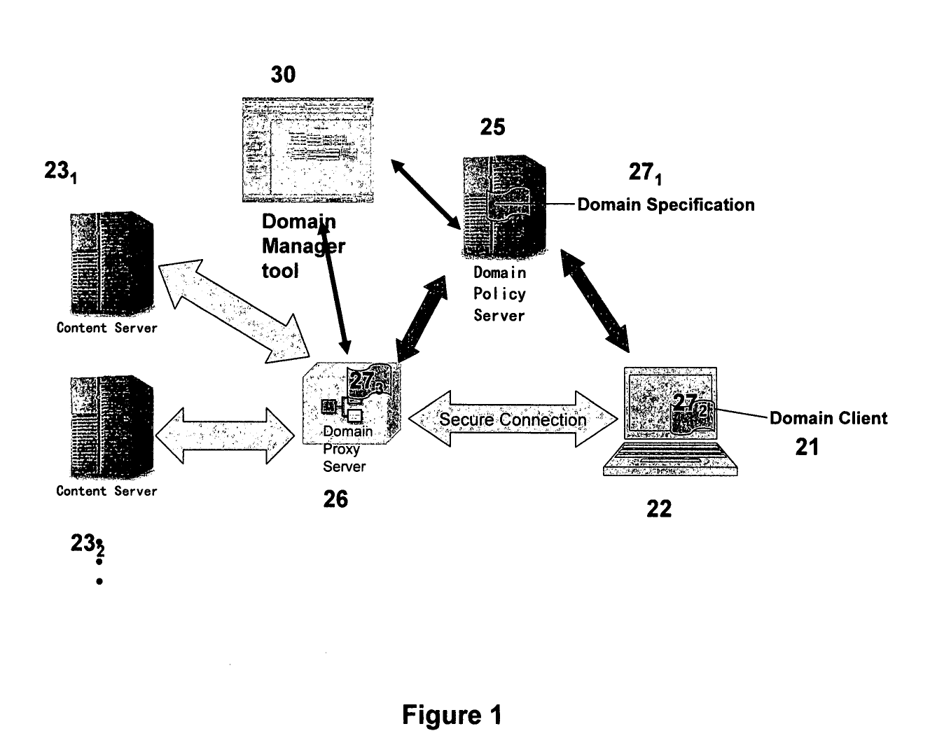

FIG. 1 illustrates the relationships among the domain policy server, domain client machine, domain proxy server as an example of implementing the virtual security domain in accordance with the invention. The domain client endpoint of the secure connection 21 is an application operating on a computing device 22 by a user to access some data on the content server 23. Data will be transmitted via the secure connection to the endpoint 22 through the domain proxy server 26. The domain proxy server 25 is a software module that can be run on any existing network hardware or an existing server device. The domain policy server 25 is a server that is the repository for the domain policies. The policy server contains the policy specification 27 for a particular secure connection and is applied to the domain client 21 and domain proxy 23 to ensure the secure connection is allowed between the domain client and content, and the particular data can be accessed and delivered from the content server to the client. In this example, the computing devices for the domain endpoint may be a typical personal computer that has network connectivity, sufficient processing power, sufficient storage and sufficient memory to operate the virtual security domain software, such as for example, a mobile phone, a personal digital assistant, various forms of computer systems including laptops, desktops, tablet computer and the like, a set-top box or any other computing device with the characteristics set forth in which it would be desirable to have a secure connection to the content server for accessing data securely.

The domain specification is managed by the administrator using the domain manager tool 30. This tool is also useful for configuring the domain proxy server getting the configuration to meet the domain specification requires.

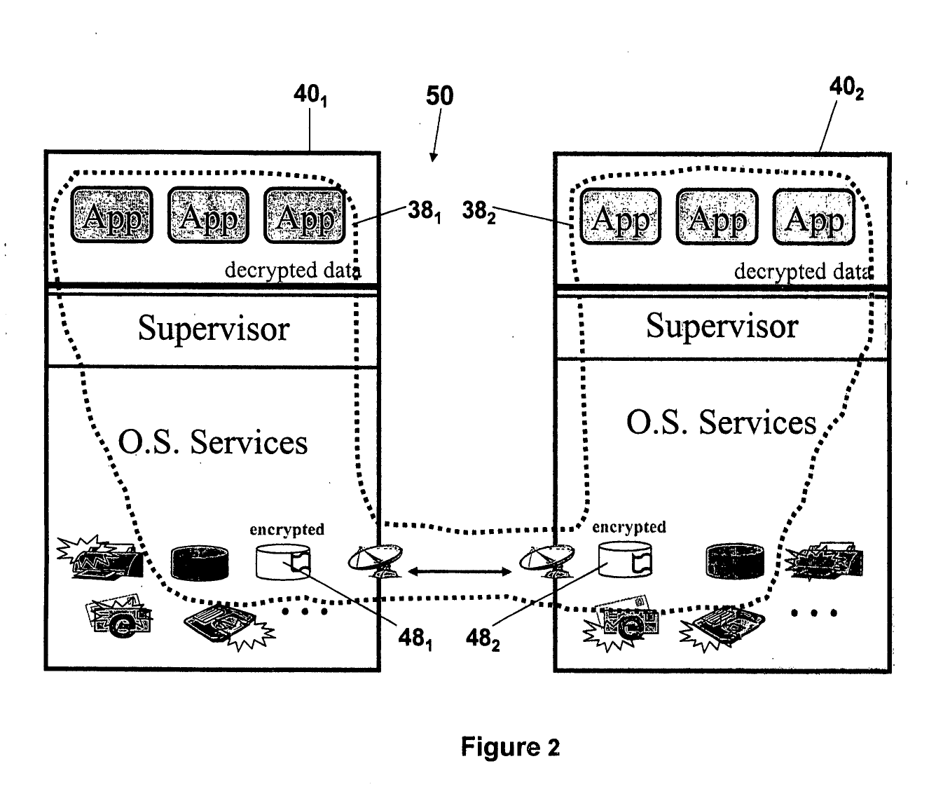

FIG. 2 illustrates an example of two domain clients residing on their computing devices 40₁, 40₂ in a virtual security domain, communicating through a secure channel. The two domain clients are able to securely exchange data (encrypted data) between the endpoints 38₁ and 38₂ on each computing device. In the example shown in FIG. 2, the endpoints include users utilize one of the applications to access their own data on 48₁ and the other endpoint's data on 48₂ securely using the virtual security domain.

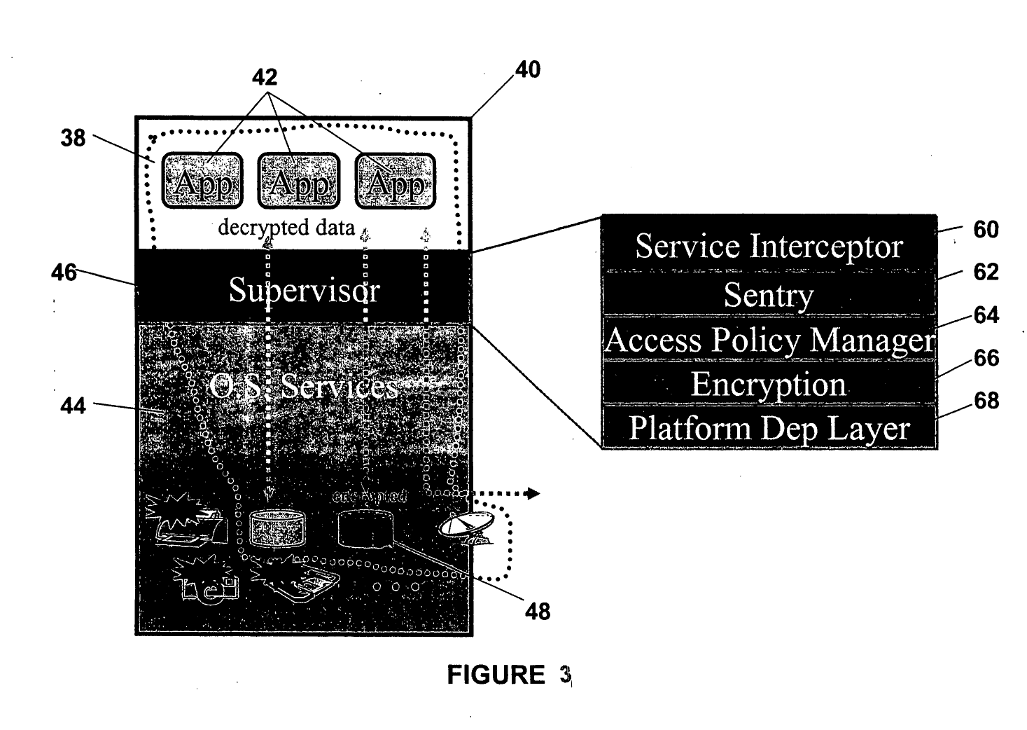

FIG. 3 illustrates further details of the secure virtual domain functions on a computing device. The supervisor of the virtual security domain 46 may further comprise one or more modules that may preferably be a piece of software that performs a certain function as described below. The supervisor, in the preferred embodiment, further comprises a service interceptor module 60, a sentry module 62, a domain specification manager module 64, an encryption module 66 and a platform dependent layer 68. In general, the supervisor intercepts the data and communications between the applications 42 and the operating system services 44 to ensure the security of the data are according to the domain specification. The interceptor module 60 is a thin layer between the core OS services and the applications that intercepts the applications' service requests and the delegates to the domain specifications manager module 64 for access control and secure auditing. The sentry module 62, during the execution of the virtual security domain session, monitors and maintains the access policy and control derived for the virtual security domain session and the configuration is used to validate the configuration and control the identity, the tools, and the accessibility of the data.

The domain specification manager module 64 provides rule-based access control that includes identifying all applications included dynamically inside the domain. The domain specification manager module 64 also grants or denies access to secure data by an application based on the access policy and the state of the domain. One of the functions of the domain specification manager module is to develop a fingerprint that uniquely identifies a tool executable. In the system, a fingerprint is created during planning time for each application in the domain, and it is used to validate the application when it is one parameter of the endpoint.

The encryption module 66 ensures that the data and communications are encrypted. The encryption key and the distribution method are securely managed to ensure the connection is a secure one. The platform dependent layer 68 contains all platform specific functions.

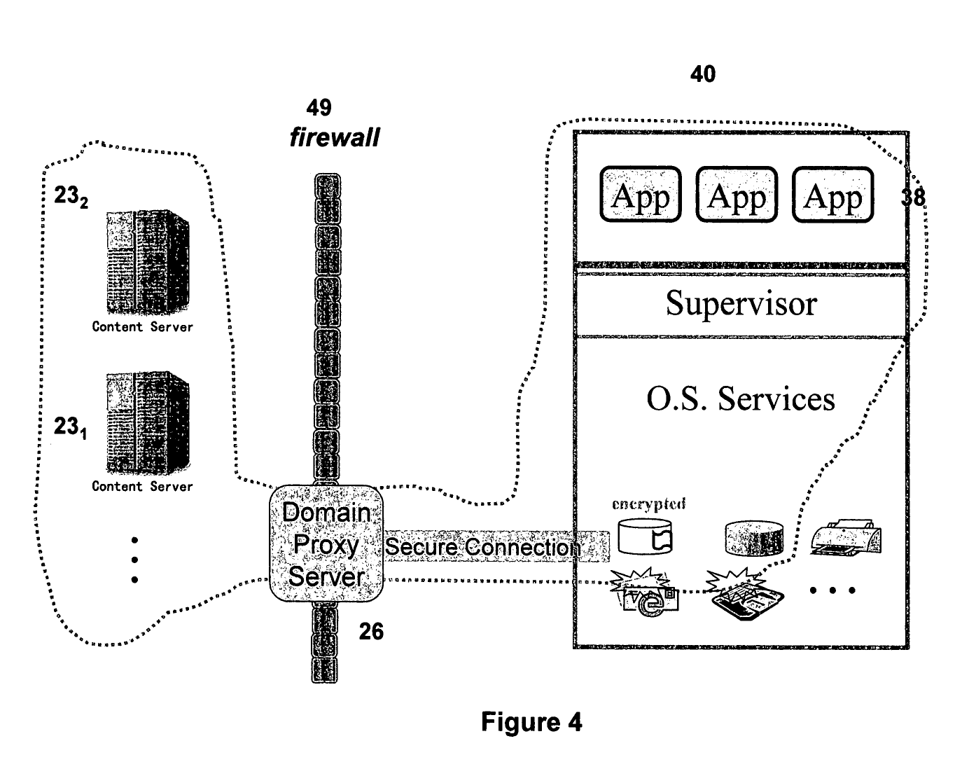

FIG. 4 illustrates an example of a domain client's computing device 40 communicating to a domain proxy server 26 through a secure channel to gain access to some content servers protected by the firewall 49. This is an example of how the virtual security domain leverages the existing secure network infrastructure, for example a firewall. Virtual security domain is to extend the security and protection of the data further into the new endpoint of the network connection, a point on the desktop where application 38 resides and when the application is being used by a user to access a piece of data.

While the foregoing has been with reference to a particular embodiment of the invention, it will be appreciated by those skilled in the art that changes in this embodiment may be made without departing from the principles and spirit of the invention, the scope of which is defined by the appended claims.

1. A method of creating a secure network access method, called virtual security domain, on a computing device, the method comprising:
defining a particular virtual security domain on the computing device, the particular virtual security domain includes a list of users as the virtual security domain members, a secure network configuration, a unique domain encrypt key, and a set of access policies for accessing the secure data and communication channels;
validating, when a user is making a request to enter the virtual security domain, only a domain member with a proper access privilege can enter the domain and access the network and secured content;
monitoring, after a validated user enters the virtual security domain, when a piece of secure content in virtual security domain is accessed by an application, that the application cannot leak any part of the secure content outside of the virtual security domain;
monitoring, during the period when the piece of content is decrypted, operations of the computing device that are capable of producing one of a complete copy and a partial copy of the piece of content;
determining, when an operation to produce a copy of the content is detected, to disallow the operation if the application and/or the operation is not permitted according to the access policies; and
copying, if the copy operation is not disallowed, the piece of content within the particular domain so that the copied piece of content is stored in secured format.

2. The method of claim 1 further comprises of a domain specification, which includes (a) a list of users and machines identities as the domain members, (b) trusted network access addresses and communication channels, (c) access policies of the domain secure contents stored in the client machine, (d) domain identity, (e) domain encryption key.

3. The method of claim 1 further comprising creating a security layer on the domain client's computing device, the accessing, verifying, monitoring, determining and copying steps being performed by the security layer wherein the security layer has a local copy of the domain specification so that the access policy in the domain specification is validated during the operation of the particular virtual security domain.

4. The method of claim 1 further comprises of a domain proxy server, controlling, validating and redirecting network access based on the domain specifications of a list of virtual security domains.

5. The method of claim 3 further comprising a set of secure communication channels, each between two domain clients' computing devices or a domain client's computing device and a domain proxy server, through which the data transfer is encrypted by a unique encryption key.

6. The method of claim 3 further comprising creating an encrypted storage in the client's computing device, storing any contents received from the secure channels, where any secured contents received and stored in the client machine will be protected under encryption and access control to prevent leakage outside of the secure domain.

7. The method of claim 6 further comprising automatically tagging of any application as “contaminated” if the application either (a) receives data from the secure communication channel, or (b) accesses data stored in the local secured store, or (c) receive data through any inter-process communication means from a contaminated process; furthermore, preventing any contaminated process either sending data to any non-secure channel, or storing to any storage device other than the encrypted storage.

8. The method of claim 1 further comprises of a domain policy computing device, through which a user, a.k.a. the virtual security domain administrator, can define and configure the domain specification, and under which the real-time management of the domain proxy server and the secure layer in the domain clients' computing devices can be easily performed.

9. The method of claim 3 further comprising communicating, with a remote domain policy computing device, to perform the following two tasks: (1) receive the latest domain specification, and (2) sending audit records indicating any illegal attempt to transfer secure contents outside of the domain.

10. The method of claim 3 further comprising transferring the domain specification from the remote domain policy computing device to the computing devices. The transferred domain specification can be optionally persisted in an encrypted form on the domain client's computing device so that the access control and secure communication channel can still function within a predefined off-line duration setting in the domain specification.

11. The method of claim 8, wherein encrypting the domain specification and encrypted storage content using an encryption key further comprising generating a unique encryption key and a unique domain identifier for each virtual security domain so that the secure environment is separated by domain boundary.

12. An apparatus for securing a virtual security domain on a computing device, the apparatus comprising:
one or more applications executed by a processing unit of the domain client's computing device that perform operations on the secure channels or the encrypted storage in a virtual security domain;
an operating system executed by the processing unit of the computing device;
a supervisor unit being executed by the processing unit of the computing device, the supervisor unit in between the one or more applications and the operating system to maintain the security of the data stored in the encrypted storage with respect to the access policy defined in the domain specification;
the supervisor unit further comprising means for accessing the encrypted storage by a user application in access policy wherein the content is decrypted while being accessed, means for verifying, when a piece of content is accessed by an application, means for monitoring, during the period when the piece of content is decrypted, operations of the computing device that are capable of producing one of a complete copy and a partial copy of the piece of content, means for determining, when an operation to produce a copy of the content is detected, to disallow the sending through un-secure channels or copying to storage device outside of the encrypted storage if contaminated.

13. The apparatus of claim 12 further comprising a supervisor unit on the computing device, the supervisor unit having a local copy of the domain specification for the virtual security domain, the supervisor unit including the accessing means, the verifying means, the monitoring means, the determining means and the copying means.

14. The apparatus of claim 13 further comprising a remote domain policy computing device and wherein the supervisor unit further comprises means for communicating, with the remote domain policy computing device, to receive the domain specification.

15. The apparatus of claim 14, wherein the remote domain policy computing device further comprises a database management system that stores one or more domain specifications for one or more virtual security domain, a random number generator to generate a unique domain encryption key upon virtual security domain creation so that data in each virtual security domain is separately secured, and a web user interface that permits a user to manage the remote domain policy computing device.

16. The apparatus of claim 15, wherein each access policy further comprises one or more rules that determine a set of access policy of a particular user using a set of factors, the set of factors further comprising an identity of each user, an identity to an application, a previous access history of the running application instance, a time, a place where the access takes place, and a path of accessing the piece of content.

17. The apparatus of claim 16, wherein the monitoring means further comprises means for automatically tagging applications as “contaminated” if the application either (a) received data from a secure channel, or (b) access encrypted storage, or (c) receive data through inter-process communication from a contaminated process.

18. The apparatus of claim 13 further comprising two or more computing devices whose users are each a member of a virtual security domain with a unique encryption key and a set of secure channels between the two or more computing devices using the unique encryption key, wherein the secure channels further comprises one of a network channel and an email channel.
